(19) United States
(12) Patent Application Publication
(10) Pub. No.: US 2022/0103415 A1
(43) Pub. Date: Mar. 31, 2022

(54) REMOTE NETWORK AND CLOUD INFRASTRUCTURE MANAGEMENT

(71) Applicant: MobileNOC Corporation, Flemington, NJ (US)

(72) Inventor: Frantz Calixte-Civil, Flemington, NJ (US)

(21) Appl. No.: 17/484,810

(22) Filed: Sep. 24, 2021

Related U.S. Application Data
(60) Provisional application No. 63/084,304, filed on Sep. 28, 2020.

(51) Int. Cl. H04L 12/24; H04L 12/46

(52) U.S. Cl. CPC H04L 41/048; H04L 12/4633

(57) ABSTRACT

A single API is provided for all network and cloud infrastructure management, automation, and operations, such that any remote device may be used as a self-organizing network (SON) controller. Infrastructure engineers, managers, and executives can manage and administer any component of enterprise IT infrastructure from a remote or IOT device. Machine learning and artificial intelligence (ML/AI) are leveraged for auto healing and network operations.

### CROSS-REFERENCE TO RELATED APPLICATIONS

This application claims priority to U.S. provisional application No. 63/084,304, entitled Remote Network and Cloud Infrastructure Management, and filed on Sep. 28, 2020, which document is incorporated herein in its entirety by this reference thereto.

### FIELD

Various of the disclosed embodiments concern remote network and cloud infrastructure management.

### BACKGROUND

The biggest pain points for IT infrastructure personnel include limited resources and time for network and cloud infrastructure management. IT infrastructure personnel are responsible for a multitude of IT infrastructure management tasks, e.g. in operations for outage Response Time/First Action time (RT/FA), as well as infrastructure visibility, security visibility, mitigating cyberattacks, configuration management, addressing too many vendors and operating systems (OSs), and box-by-box only Command Line Interface based administration (CLI), snapshots and backups, vendor and carrier support, office or virtual private network (VPN) support, email, and tickets.

### SUMMARY

Embodiments of the invention combine the power of mobile and Internet-of-things (IoT) with network infrastructure monitoring, management, automation, and AINetOps to transform any company's existing network to a NextGen network. AINetOps is accomplished by leveraging machine learning and analytics to trigger automated actions, responses, fixes, and first action for IT operations tasks and incidents. The invention allows IT professionals to manage their entire infrastructure (routing, switch, cloud, compute, security, firewall, storage, wireless, TAC, carrier, from a smartphone, tablet, smartwatch, infotainment system, smart glass, or drone.

Embodiments provide a single API for all network and cloud infrastructure management, automation, and operation, thus transforming any remote device into a self-organizing network (SON) controller.

Embodiments of the invention allow infrastructure engineers, managers, and executives to manage and administer any component of enterprise IT infrastructure from a remote or IOT device.

Embodiments also leverage machine learning and artificial intelligence (ML/AI) for auto healing and network operations.

### BRIEF DESCRIPTION OF THE DRAWINGS

FIG. 1 is a block diagram showing a system for remote network and cloud infrastructure monitoring;

FIG. 2 is an architectural diagram showing a system for remote network and cloud infrastructure management according to an embodiment of the invention;

FIG. 3 is a block diagram showing a system for remote network and cloud infrastructure management according to an embodiment of the invention;

FIG. 4 is a detailed block diagram showing a system for remote network and cloud infrastructure management according to an embodiment of the invention;

FIG. 5 is a block diagram showing a system for leverage machine learning and artificial intelligence (ML/AI) for auto healing and network operations;

FIG. 6 is a block diagram showing a further view of a system for remote network and cloud infrastructure management;

FIG. 7 shows a remote device with which an embodiment provides real time visibility of network infrastructure;

FIG. 8 shows a remote device with which an embodiment provides Layer 2 and Layer 3 interface visibility and configuration;

FIG. 9 shows a remote device with which an embodiment provides visualization of CDP and LLDP neighbors;

FIG. 10 shows a remote device with which an embodiment provides IT infrastructure personnel the ability to open TAC cases easily and view all current and past TAC tickets;

FIG. 11 shows a remote device with which an embodiment provides IT infrastructure personnel with the ability to open carrier cases easily and view all current and past TAC tickets and device data and contract information;

FIG. 12 shows a remote device with which an embodiment provides private cloud/vcenter visibility and management;

FIG. 13 shows a remote device with which an embodiment provides IT infrastructure personnel with public cloud visibility and management;

FIG. 14 shows a remote device with which an embodiment provides IT infrastructure personnel with firewall visibility and management;

FIG. 15 shows a remote device with which an embodiment provides IT infrastructure personnel with routing visibility and management;

FIG. 16 shows a remote device with which an embodiment provides IT infrastructure personnel with instant datacenter visibility;

FIG. 17 shows a remote device with which an embodiment provides IT infrastructure personnel with easy collaborations;

FIG. 18 shows a remote device with which an embodiment provides IT infrastructure personnel with an infrastructure timeline for all alerts, incidents, changes and updates;

FIG. 19 shows a remote device with which an embodiment provides IT infrastructure personnel with security visibility and instant action; and

FIG. 20 is a block diagram illustrating an example of a processing system in which at least some operations described herein can be implemented.

### DETAILED DESCRIPTION

Embodiments of the invention make life easier for IT infrastructure engineers, managers, and executives by combining the power of mobile and Internet-of-things (IOT) with network infrastructure management, automation, and AINetOps to transform any company's existing network to a NextGen network. AINetOps is accomplished by leveraging machine learning and analytics to trigger automated actions, responses, fixes, and first action for IT operations tasks and incidents.

Embodiments provide a single API for all network and cloud infrastructure management, automation, and operations to transform any remote device into a SON controller.

Embodiments of the invention allow infrastructure engineers, managers, and executives to manage and administer any component of enterprise IT infrastructure from a remote or IOT device.

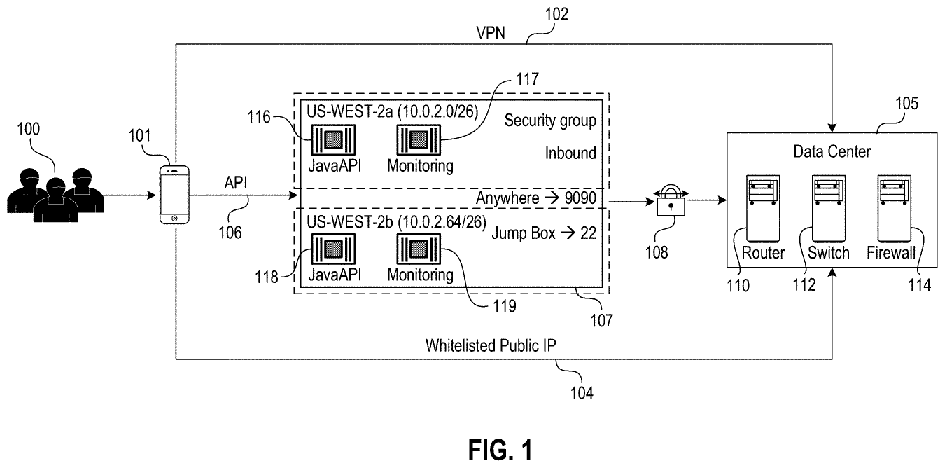

FIG. 1 is a block diagram showing a system for remote network and cloud infrastructure monitoring, configuration, automation, and operations. In FIG. 1, one or more IT infrastructure personnel 100 use a remote device 101 to communicate with a data center 105 comprising, for example, one or more routers 110, switches 112, and firewalls 114. The remote device may be an iOS or Android device or any other remote device and may also include personal computers or IOT devices, such as smartwatches, smart glasses, or drones. The remote devices may communicate with the data center via the Internet and may access the Internet via Wi-Fi, cellular, or any other network. The remote device typically accesses a data center via a virtual private network (VPN) 102 or whitelisted public IP address 104.

In embodiments, the remote device accesses the data center via an API call 106 to a MOS (Mobile Operating System) module 107 and thence, via a secure channel 108. The MOS module 107 comprises an API which, in an embodiment, is a Java API 116/118 and Python API. A monitoring function 117/119 is also provided.

The MOS is an operating system capable of running on any remote or IOT device, e.g. smartphone, tablet, smartwatch, smart glass, drone, infotainment system, or any smart device. The MOS is powered by a controller (physical or virtual appliance) which consists of both a Java and Python API. The Java and Python API both collect data from network devices and send the data to front end remote and IOT devices. The Java and Python API also contain scripts that provide the ability to perform any IT infrastructure task.

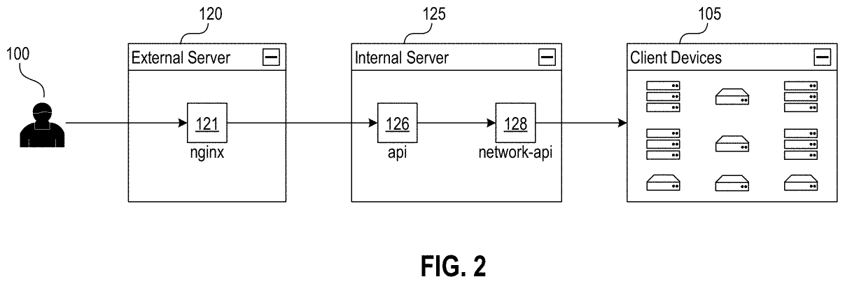

FIG. 2 is an architectural diagram showing a system for remote network and cloud infrastructure management according to an embodiment of the invention.

In an embodiment, every service, for example, nginx-external 120, api 126, network-api 128, etc. is dockerized, i.e. it is based on a is a tool that seamlessly executes commands in a container. A dockerized service takes care of the details so that a command can be run in a container as if it was running on the host machine. It is only necessary to prepend a command with a dockerized exec to have it run in the container.

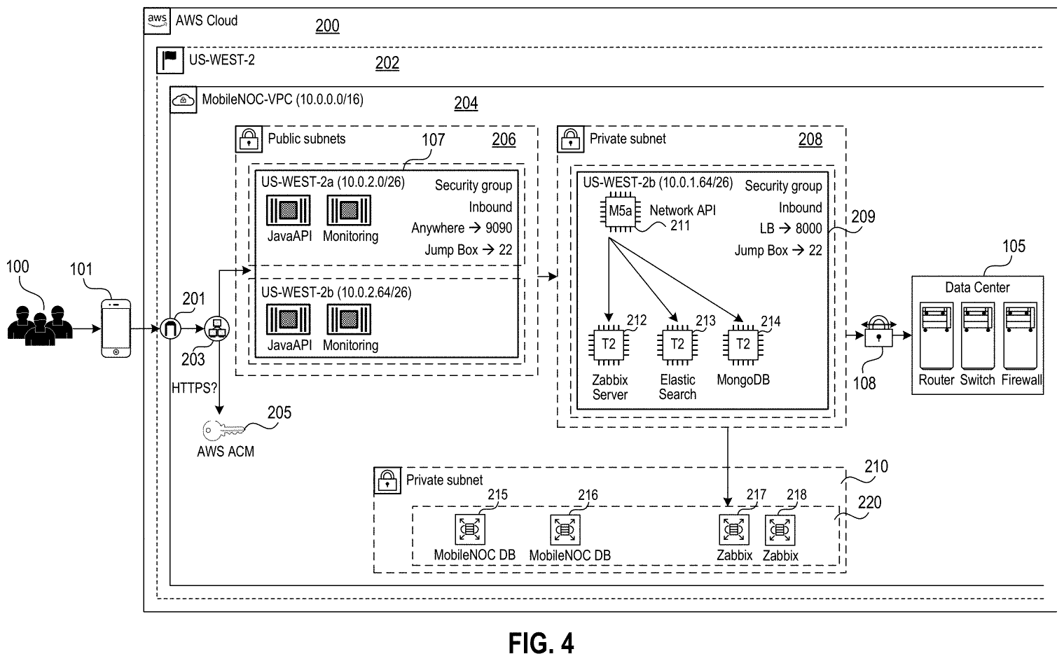

In embodiments, only the external server 120 is accessible via the Internet; the internal server 125 (see FIG. 4: 209/220) should only be reachable by the external server and should be able to reach the network devices 105 of the client.

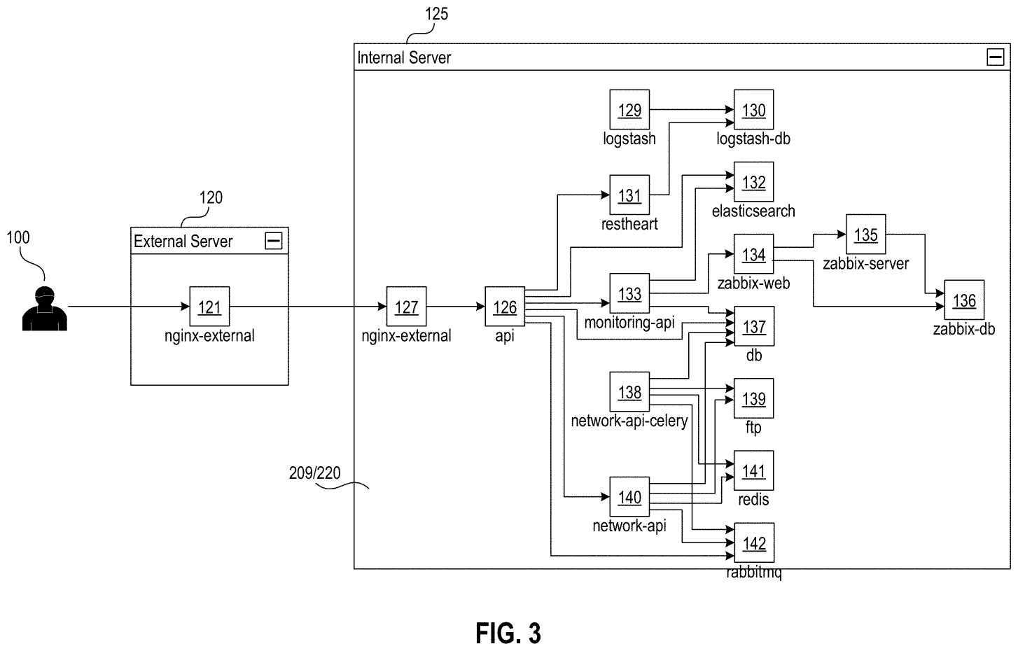

FIG. 3 is a block diagram showing a system for remote network and cloud infrastructure management according to an embodiment of the invention.

The following is noted:

### Port Requirements

In embodiments, the following port requirements are set. Those skilled in the art will appreciate that other port requirements may be used in connection with the invention.

Public/Internet to External Server
443 - nginx-external
External Server to Internal Server
9090 - api
Internal Network (Network Devices) to Internal Server
21 - ftp
30000-30099 - ftp passive mode
514 tcp - syslog
514 udp - syslog

### Services

Nginx External 121: nginx-external forwards all requests to nginx-internal in the internal server. This should be the only service directly accessible via the Internet

Nginx Internal 127: nginx-internal forwards all requests from nginx-external to the api.

API 126: api also known as Java API, performs various functions such as:
Process requests and forward them to the Python APIs (network-api and monitoring-api) so they can use network libraries to connect to the network devices;
Use REST API calls to connect to network devices; and
Perform various functions with external services, such as Servicenow or Firebase.

Network API 128: network-api is the api which connects to the network devices in the client network. This service is focused on network device related functionality.

Network API Celery 138: network-api-celery is a helper service to network-api which provides asynchronous functionality.

Monitoring API 133: monitoring-api connects to a monitoring system, such as zabbix and monitors device status.

Logstash 129: logstash is a service which collects logs from network devices and stores them in a MongoDB database.

Logstash DB 130: logstash-db is a MongoDB database which stores logs from Logstash.

Restheart 131: restheart is an API for MongoDB databases. Embodiments use restheart to query data from the mongodb database which stores logstash information, such as network device logs.

Elasticsearch 132: elasticsearch is used for storing monitoring system alerts.

Database 137: db is a MySQL Database which is the main database for the services. It contains all network device data and anything required by the APIs.

Zabbix Web 134: zabbix-web is the frontend of Zabbix and consists of an API for retrieving Zabbix DB data.

Zabbix Server 135: zabbix-server is the core service for Zabbix.

Zabbix DB 136: zabbix-db is a MySQL database for Zabbix.

FTP 139: ftp is used for saving network device snapshots or ISO image files used for updating/upgrading network device version.

Redis 141: redis is used for network-api asynchronous functionality.

RabbitMQ 142: rabbitmq is used for network-api asynchronous functionality.

FIG. 4 is a detailed block diagram showing a system for remote network and cloud infrastructure management according to an embodiment of the invention.

In FIG. 4, one or more IT infrastructure personnel 100 use a remote device having a dedicated app 101 to communicate with a data center 105 comprising, for example, one or more routers, switches, and firewalls. The remote device may be an iOS or

Android device or any other remote device and may also include personal computers. The remote devices may communicate with the data center via the Internet and may access the Internet via Wi-Fi, cellular, or any other network.

In embodiments, the remote device accesses the cloud via a cloud service, such as

Amazon Web Services (AWS) 200 and a carrier 202, such as US West. Key to the invention is an intermediary module 204 to which communications 201 from the remote device are directed. Security is provided, for example by use of HTTPS 203 and a session key 205.

Remote device communications proceed via a public subnet module 206 that includes a module 107. FIG. 4 explains the flow of command execution through the platform. There are at least two ways that the command gets executed in embodiments of the invention:

1. Executing commands through the API. As can be seen in the FIG. 4. Users 100 open a screen on an application associated the intermediary module 204. Upon opening the screen the application hits an API endpoint. The API endpoint is RestFul based where it validates the incoming request. It validates the token of the user to make sure that the user is authorized to call that specific API. Because embodiments of the intermediary module 204 offer three levels of security, all of the security rules should be passed to pass through the request.

Once the request passes the API, the JavaAPI 116 creates an internal call to another micro service which generates a native command that works on the device, based on configurations provided for each device. These internal calls are private and not exposed to the Internet, as can be seen in 108.

Once the command is generated, an SSH tunnel is opened to the device and then the command is executed. The SSH tunnel is also secured because it must go through the firewall. Once the command is executed, a Python micro service parses the response and then it converts it to a JSON based response.

2. Direct connection to the device. In embodiments the direct connection can happen in at least two ways, either through a VPN connection 102 or by whitelisting the public IP address of the remote device on the firewall level that accesses a private subnet 210. The private subnet includes a module 220 (see FIG. 3) that includes one or more databases 215, 216.

Communications proceed from the public subnets to a private subnet 208 that includes a NetAI module 209 (see FIG. 3) which includes a network API 211. The module comprises a Zabbix server 212, which performs the polling and trapping of data, calculates triggers, and sends notifications to users. It is the central component to which Zabbix agents and proxies report data on availability and integrity of systems. The Zabbix server accesses one or more Zabbix databases 217, 218 which comprise a central repository in which configuration, statistical, and operational data is stored. The module also comprises an Elastic search facility 213, i.e. a distributed, RESTful search and analytics engine capable of addressing a growing number of use cases which provides a distributed, multitenant-capable full-text search engine with an HTTP web interface and schema-free JSON documents. Finally, the module comprises a database, such as the MongoDB 214, which is a cross-platform document-oriented database program. This orchestrates the data between backend devices, e.g. routers, switches, firewalls, servers, load balancers, etc., and provides the status, data, and configuration capabilities from backend devices to smart devices, e.g. smartphones, tablets, smartwatches, smart glasses, drones.

In embodiments, the remote device accesses the data center as described above and, thence, via a secure channel 108.

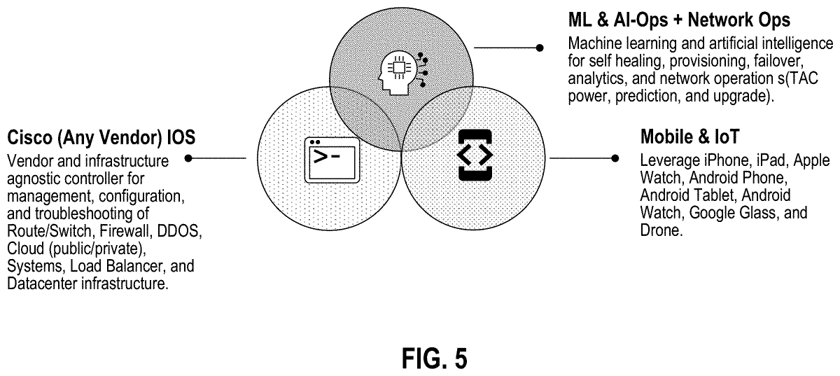

Embodiments leverage machine learning and artificial intelligence (ML/AI) for auto healing and network operations (see FIG. 5).

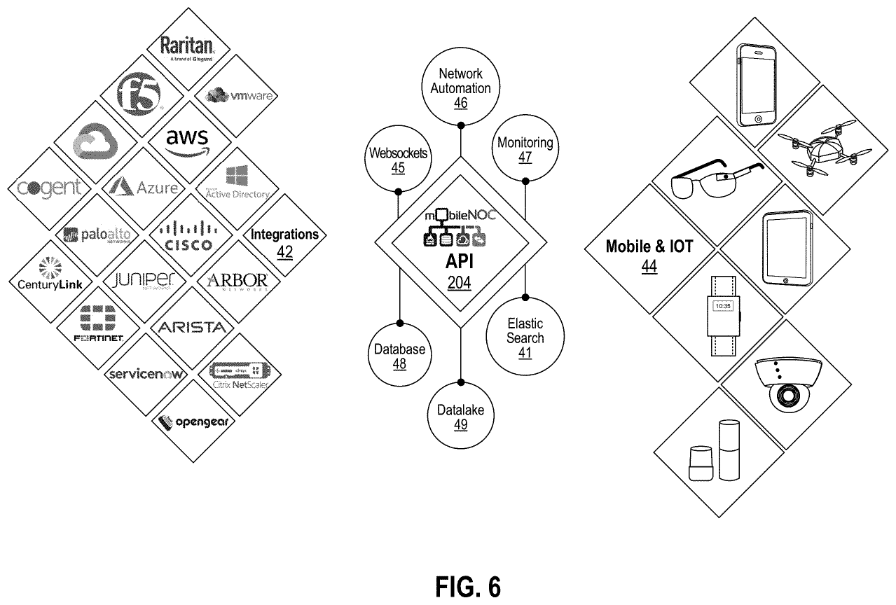

FIG. 6 is a block diagram showing a further view of a system for remote network and cloud infrastructure management. In FIG. 6, the intermediary module 204 interfaces various remote and IoT devices 44, such as smartphones, drones, smart glasses, pad computers, smartwatches, cameras, and other devices with various system integrations 42. The intermediary module 204 operates in connection with associated systems such as network automation 46, monitoring systems 47, web sockets 45, databases 48, data lakes 49, and Elastic search 41.

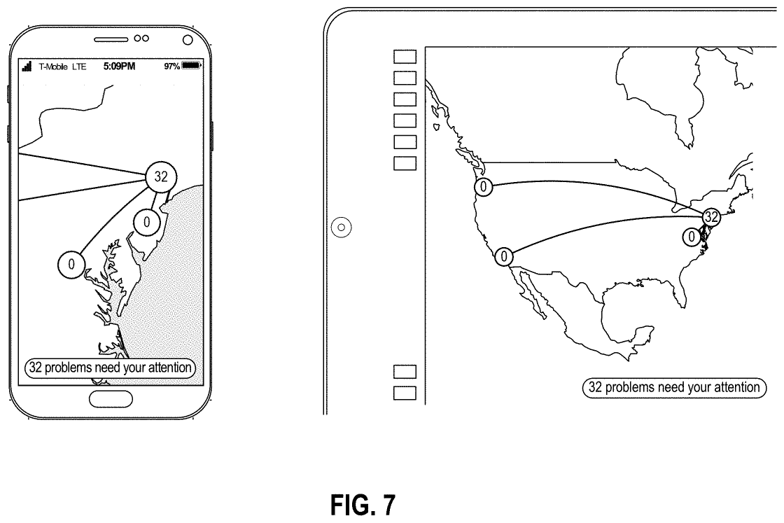

Embodiments of the invention provide real time visibility of all networks and nodes around the globe. Real time visibility is provided from a single point of management. Response time is increased. IT infrastructure personnel can view any device or latency changes and immediately view decreasing downtime and cost. FIG. 7 shows a remote device with which an embodiment provides real time visibility of network infrastructure.

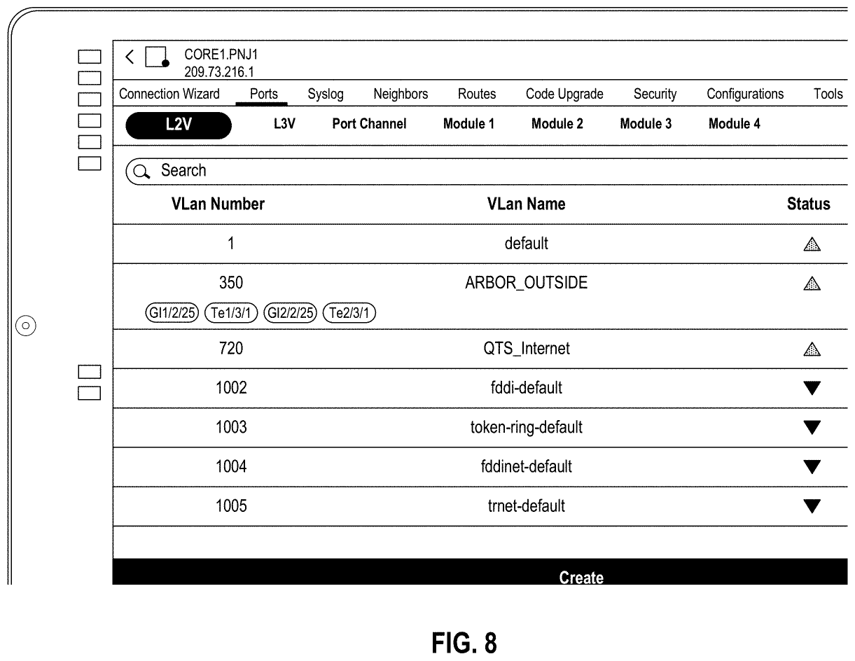

Embodiments of the invention provide Layer 2 and Layer 3 interface visibility and configuration. IT infrastructure personnel can view all Layer 2 and Layer 3 interfaces, as well as VLAN/port memberships, interface status, and MAC address information. IT infrastructure personnel can also make configuration changes. FIG. 8 shows a remote device with which an embodiment provides Layer 2 and Layer 3 interface visibility and configuration.

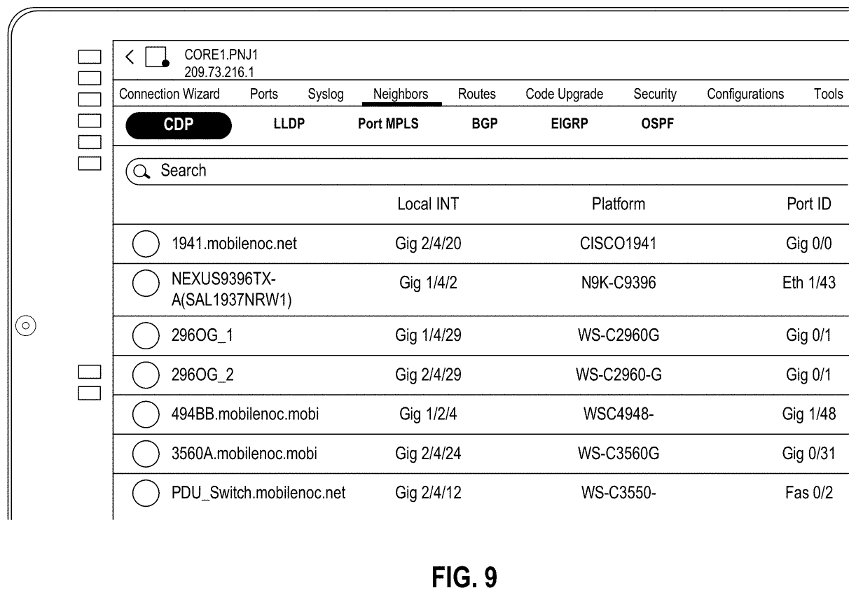

Embodiments provide visualization of Cisco discovery protocol (CDP) and link layer discovery protocol (LLDP) neighbors, including real time visibility and visibility for Layer 2 adjacencies. FIG. 9 shows a remote device with which an embodiment provides visualization of CDP and LLDP neighbors.

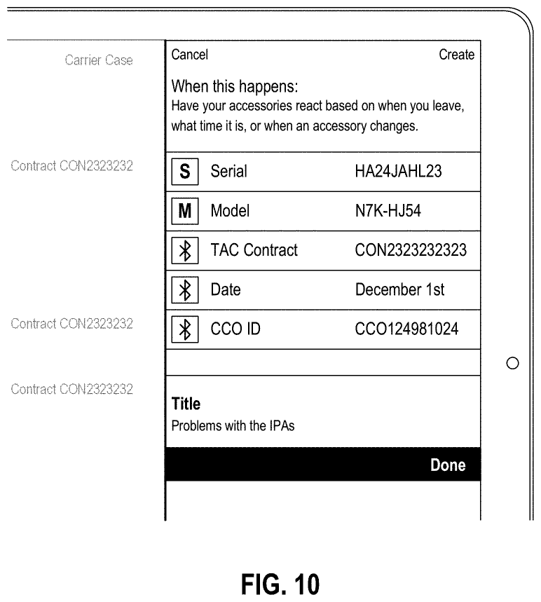

Embodiments provide a tool with which IT infrastructure personnel can easily open technical assistance center (TAC) cases and view all current and past TAC tickets. In this way, response time is increased, and device data and contract information are easily viewed. FIG. 10 shows a remote device with which an embodiment provides IT infrastructure personnel the ability to open TAC cases easily and view all current and past TAC tickets.

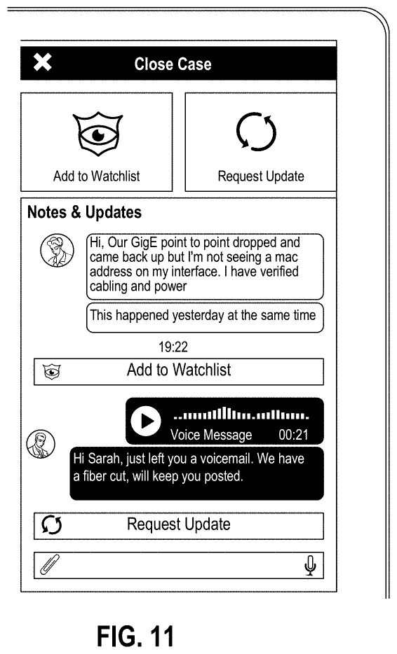

Embodiments provide a tool with which IT infrastructure personnel can easily open carrier cases and view all current and past TAC tickets and device data and contract information. Embodiments provide automated circuit troubleshooting, allow IT infrastructure personnel to open carrier tickets easily, allow real time collaboration with the carrier, and thus provide faster resolution time. FIG. 11 shows a remote device with which an embodiment provides IT infrastructure personnel with the ability to open carrier cases easily and view all current and past TAC tickets and device data and contract information.

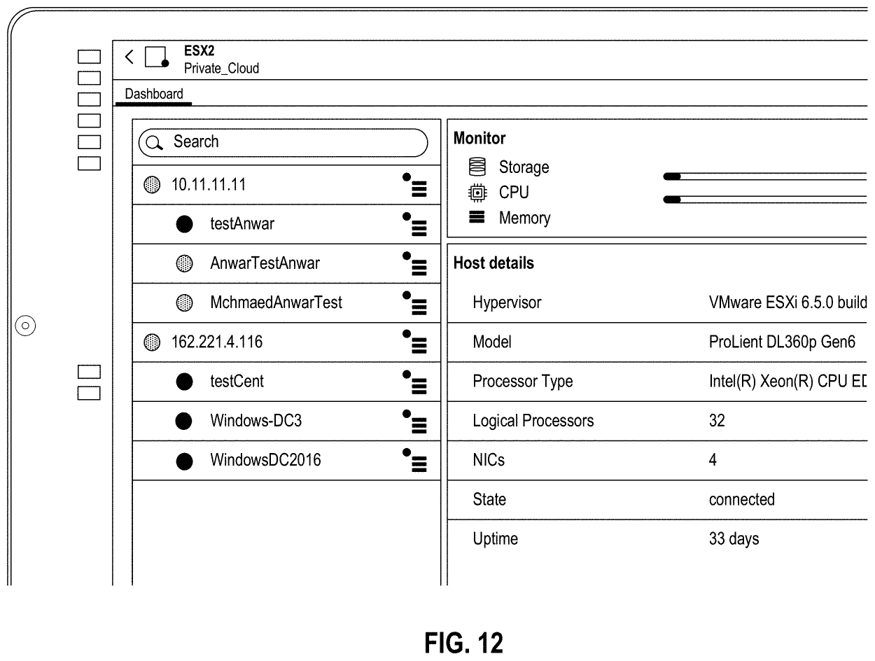

Embodiments provide IT infrastructure personnel with private cloud/vcenter visibility and management. Such real time visibility allows IP infrastructure personnel to manage ESX host and virtual machines, easily deploy new services, and run RDP, SSH, or console sessions to virtual machines (VMs). FIG. 12 shows a remote device with which an embodiment provides private cloud/vcenter visibility and management.

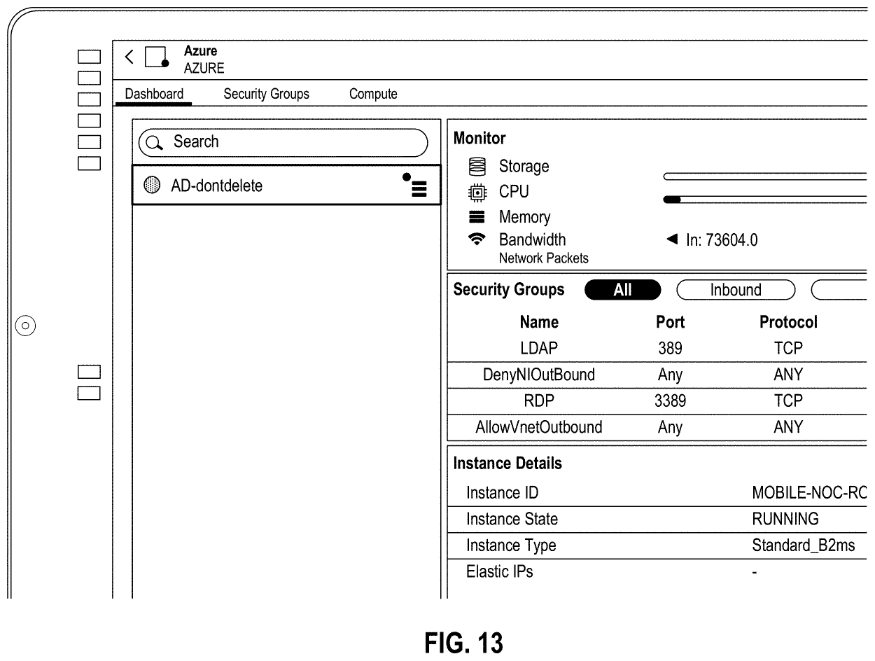

Embodiments provide IT infrastructure personnel with public cloud visibility and management. Such real time visibility allows IP infrastructure personnel to manage virtual machines, easily deploy new services, run RDP or SSH sessions to VMs, and manage security groups. FIG. 13 shows a remote device with which an embodiment provides IT infrastructure personnel with public cloud visibility and management.

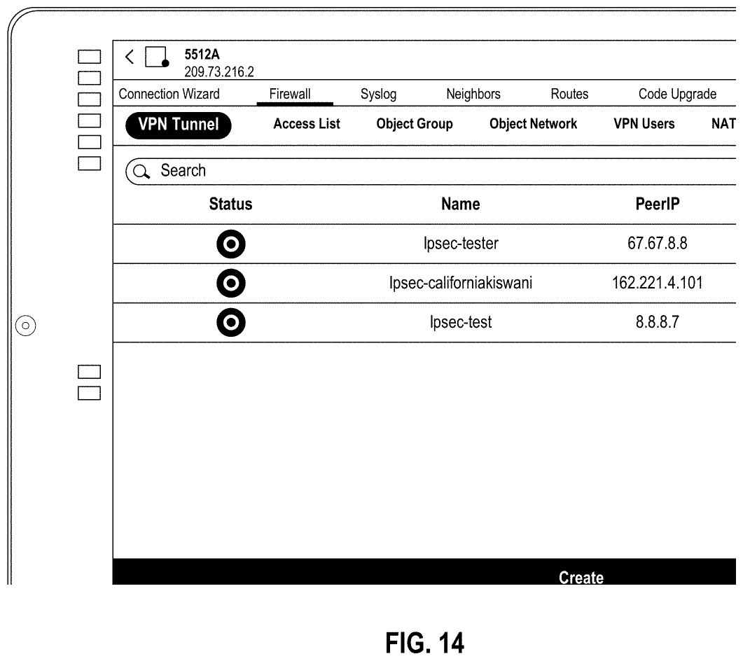

Embodiments provide IT infrastructure personnel with firewall visibility and management. Such real time security visibility allows IP infrastructure personnel to view VPN tunnel, ACL, NAT, object group/network, and VPN user details, and thereby easily mitigate security vulnerabilities. FIG. 14 shows a remote device with which an embodiment provides IT infrastructure personnel with firewall visibility and management.

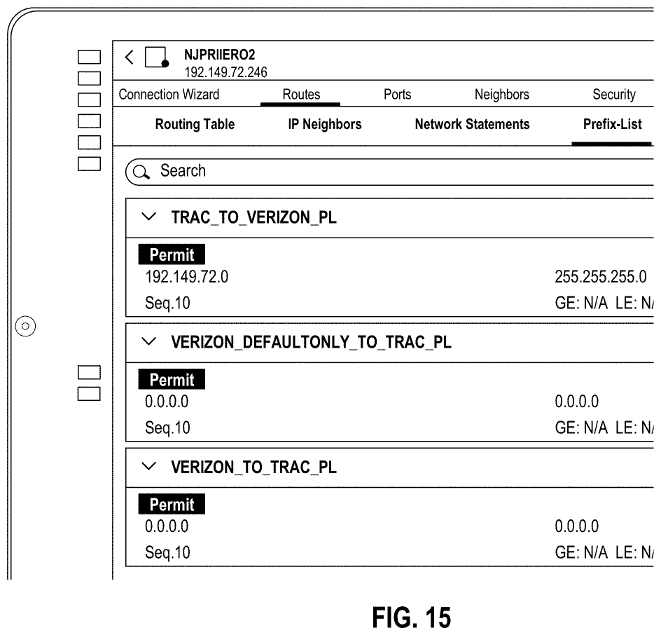

Embodiments provide IT infrastructure personnel with routing visibility and management. Such routing visibility and management visibility allows IP infrastructure personnel to view routing neighbors, view route-maps, and view prefix-lists. FIG. 15 shows a remote device with which an embodiment provides IT infrastructure personnel with routing visibility and management.

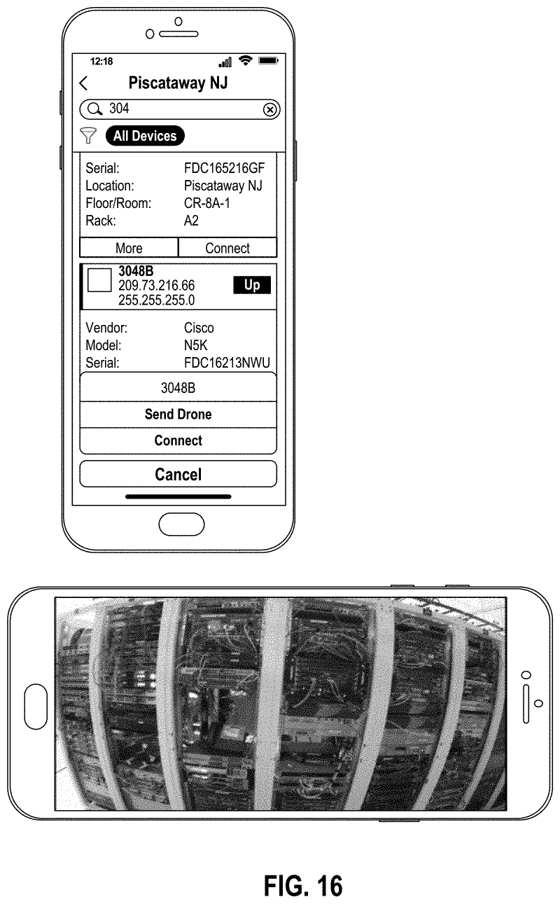

Embodiments provide IT infrastructure personnel with instant datacenter visibility. IT infrastructure personnel with can start a drone to see physically where an issue may be, thereby increasing response time, reducing down time, and increasing profit. FIG. 16 shows a remote device with which an embodiment provides IT infrastructure personnel with instant datacenter visibility.

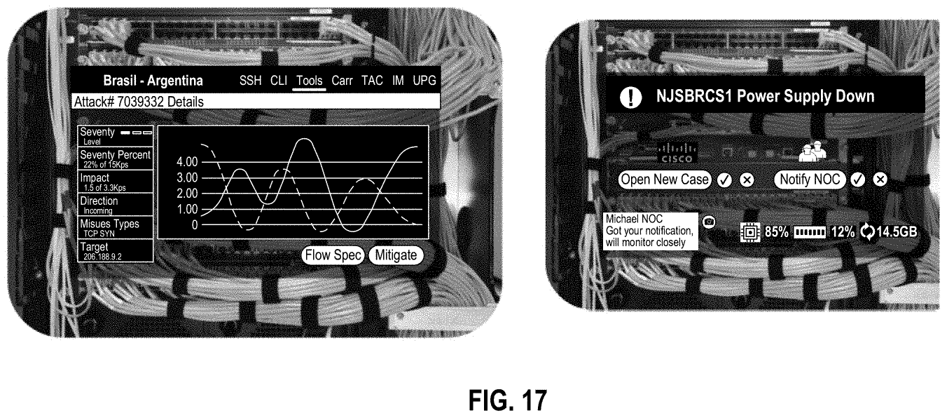

Embodiments provide IT infrastructure personnel with easy collaborations. IT infrastructure personnel can collaborate with data center engineers. IT infrastructure personnel can also leverage a virtual assistant. FIG. 17 shows a remote device with which an embodiment provides IT infrastructure personnel with easy collaborations.

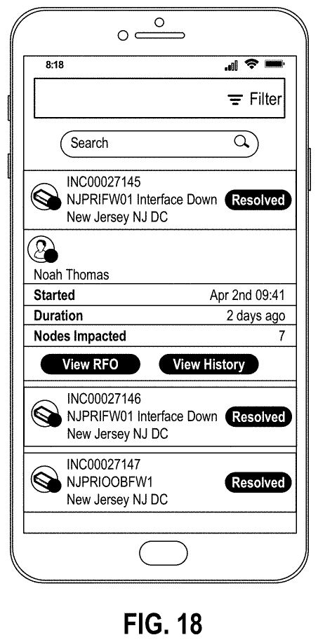

Embodiments provide IT infrastructure personnel with an infrastructure timeline for all alerts, incidents, changes and updates. Embodiments provide real time updates, a view of any changes, and a view of any carrier maintenances or issues. FIG. 18 shows a remote device with which an embodiment provides IT infrastructure personnel with an infrastructure timeline for all alerts, incidents, changes and updates.

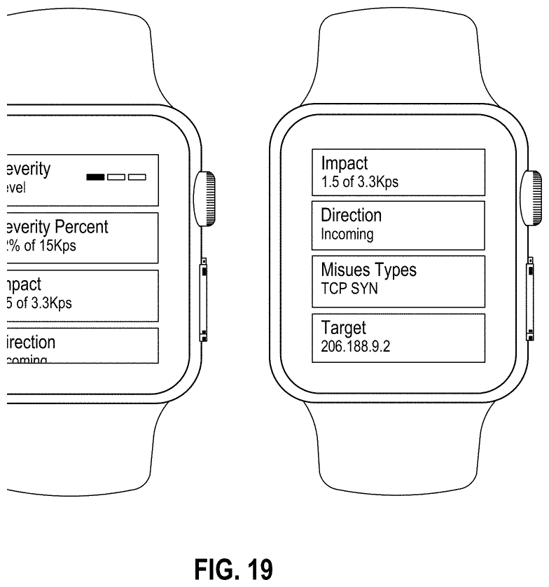

Embodiments provide IT infrastructure personnel with security visibility and instant action. Such real time visibility allows IT infrastructure personnel to mitigate any attack instantly, thus immediately decreasing downtime. FIG. 19 shows a remote device with which an embodiment provides IT infrastructure personnel with security visibility and instant action.

### Processing System

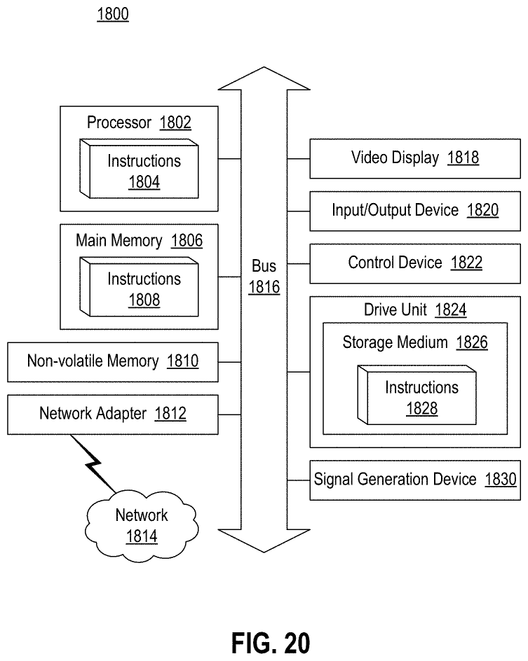

FIG. 20 is a block diagram illustrating an example of a processing system 1800 in which at least some operations described herein can be implemented. For example, components of the processing system 1800 may be hosted on a computing device that includes a threat detection platform. As another example, components of the processing system 1800 may be hosted on a computing device that is queried by a threat detection platform to acquire emails, data, etc.

The processing system 1800 may include a central processing unit (also referred to as a “processor”) 1802, main memory 1806, non-volatile memory 1810, network adapter 1812, e.g. a network interface, video display 1818, input/output device 1820, control device 1822, e.g. a keyboard or pointing device, drive unit 1824 including a storage medium 1826, and signal generation device 1830 that are communicatively connected to a bus 1816. The bus 1816 is illustrated as an abstraction that represents one or more physical buses or point-to-point connections that are connected by appropriate bridges, adapters, or controllers. The bus 1816, therefore, can include a system bus, a Peripheral

Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

The processing system 1800 may share a similar processor architecture as that of a desktop computer, tablet computer, mobile phone, game console, music player, wearable electronic device, e.g. a watch or fitness tracker, network-connected (“smart”) device, e.g. a television or home assistant device, virtual/augmented reality systems, e.g. a head-mounted display, or another electronic device capable of executing a set of instructions (sequential or otherwise) that specify actions to be taken by the processing system 1800.

While the main memory 1806, non-volatile memory 1810, and storage medium 1826 are shown to be a single medium, the terms “machine-readable medium” and “storage medium” should be taken to include a single medium or multiple media, e.g. a centralized/distributed database and/or associated caches and servers, that store one or more sets of instructions 1828. The terms “machine-readable medium” and “storage medium” shall also be taken to include any medium that is capable of storing, encoding, or carrying a set of instructions for execution by the processing system 1800.

In general, the routines executed to implement the embodiments of the disclosure may be implemented as part of an operating system or a specific application, component, program, object, module, or sequence of instructions (collectively referred to as “computer programs”). The computer programs typically comprise one or more instructions, e.g. instructions 1804, 1808, 1828, set at various times in various memory and storage devices in an electronic device. When read and executed by the processors 1802, the instruction(s) cause the processing system 1800 to perform operations to execute elements involving the various aspects of the present disclosure.

Moreover, while embodiments have been described in the context of fully functioning electronic devices, those skilled in the art will appreciate that some aspects of the technology are capable of being distributed as a program product in a variety of forms. The present disclosure applies regardless of the particular type of machine- or computer-readable media used to effect distribution.

Further examples of machine- and computer-readable media include recordable-type media, such as volatile and non-volatile memory devices 1810, removable disks, hard disk drives, and optical disks, e.g. Compact Disk Read-Only Memory (CD-ROMS) and Digital Versatile Disks (DVDs), and transmission-type media, such as digital and analog communication links.

The network adapter 1812 enables the processing system 1800 to mediate data in a network 1814 with an entity that is external to the processing system 1800 through any communication protocol supported by the processing system 1800 and the external entity. The network adapter 1812 can include a network adaptor card, a wireless network interface card, a router, an access point, a wireless router, a switch, a multilayer switch, a protocol converter, a gateway, a bridge, a bridge router, a hub, a digital media receiver, a repeater, or any combination thereof.

The network adapter 1812 may include a firewall that governs and/or manages permission to access/proxy data in a network. The firewall may also track varying levels of trust between different machines and/or applications. The firewall can be any number of modules having any combination of hardware, firmware, or software components able to enforce a predetermined set of access rights between a set of machines and applications, machines and machines, or applications and applications, e.g. to regulate the flow of traffic and resource sharing between these entities. The firewall may additionally manage and/or have access to an access control list that details permissions including the access and operation rights of an object by an individual, a machine, or an application, and the circumstances under which the permission rights stand.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A method for managing a network, comprising:
an API associated with an intermediary module validating said user network requests received from a remote device comprising a self-organizing network controller application for user entry of network requests via the remote device, said intermediary module determining that said user is authorized to call said API;
said intermediary module creating an internal call to generate a native command that works on the remote device, based on configurations provided for said remote device;
once the native command is generated, said intermediary module opening an SSH tunnel to the remote device;
said intermediary module executing the user request;
said intermediary module parsing a response to said request;
said intermediary module converting said response to a JSON based response; and
said intermediary module returning said JSON based response to said remote device.

2. The method of claim 1, further comprising:
an external server accessible via the Internet.

3. The method of claim 2, further comprising:
an internal server reachable by the external server;
wherein said internal server is configured to communicate with network devices controlled by the remote device.

4. The method of claim 3, wherein said internal server comprises a plurality of services; and
further comprising prepending a command with a dockerized exec to each service to execute commands for the service in a container.

5. The method of claim 4, wherein said services comprise any of:
nginx-external for forwarding all requests to nginx-internal in the internal server, wherein nginx-external is the only service directly accessible via the Internet;
nginx-internal for forwarding all requests from nginx-external to an api;
api for processing requests and forwarding them to a network-api and monitoring-api to use network libraries to connect to the network devices, using REST API calls to connect to network devices, and performing various functions with external services;
network-api for connecting to the network devices in a client network;
network-api-celery providing a helper service to network-api which provides asynchronous functionality;
monitoring-api for connecting to a monitoring system;
logstash for collecting logs from network devices and storing said logs in a database;
logstash-db providing a database for storing logs from logstash;
restheart providing an API for databases to query data from the database which stores logstash information;
elasticsearch for storing monitoring system alerts;
db providing a main database for services and containing all network device data and data required by the api;
zabbix-web providing a frontend for Zabbix and comprising an API for retrieving Zabbix DB data;
zabbix-server providing a core service for Zabbix;
zabbix-db providing database for Zabbix;
ftp for saving network device snapshots or ISO image files used for updating/upgrading network device version;
redis for providing network-api asynchronous functionality; and
rabbitmq for providing network-api asynchronous functionality.

6. The method of claim 1, wherein said network controller application leverages machine learning and artificial intelligence (ML/AI) for auto healing and network operations.

7. The method of claim 1, wherein said intermediary module interfaces one or more remote and IoT devices.

8. The method of claim 1, wherein said intermediary module operates in connection with associated systems comprising any of network automation, monitoring systems, web sockets, databases, data lakes, and Elastic search.

9. The method of claim 1, wherein said network controller application provides worldwide, real time visibility of all networks and nodes from a single point of management.

10. The method of claim 1, wherein said network controller application provides Layer 2 and Layer 3 interface visibility and configuration for viewing all Layer 2 and Layer 3 interfaces, and any of VLAN/port memberships, interface status, and MAC address information, and with which IT infrastructure personnel can make configuration changes.

11. The method of claim 1, wherein said network controller application provides visualization of Cisco discovery protocol (CDP) and link layer discovery protocol (LLDP) neighbors, including real time visibility and visibility for Layer 2 adjacencies.

12. The method of claim 1, wherein said network controller application opens technical assistance center (TAC) cases and allows viewing of all current and past TAC tickets.

13. The method of claim 1, wherein said network controller application opens carrier cases and allows viewing of current and past TAC tickets and device data and contract information.

14. The method of claim 1, wherein said network controller application provides automated circuit troubleshooting, allows IT infrastructure personnel to open carrier tickets, and provides real time collaboration with a carrier.

15. The method of claim 1, wherein said network controller application provides IT infrastructure personnel with private cloud/vcenter visibility and management;
wherein said real time visibility provides management of ESX host and virtual machines, deployment of new services, and running of RDP, SSH, or console sessions to virtual machines (VMs).

16. The method of claim 1, wherein said network controller application provides public cloud visibility and management of virtual machines, deployment of new services, running of RDP or SSH sessions to VMs, and management of security groups.

17. The method of claim 1, wherein said network controller application provides firewall visibility and management for viewing VPN tunnel, ACL, NAT, object group/network, and VPN user details to mitigate security vulnerabilities.

18. The method of claim 1, wherein said network controller application provides routing visibility and management for viewing routing neighbors, view route-maps, and view prefix-lists.

19. The method of claim 1, wherein said network controller application provides instant datacenter visibility for starting a drone to see physically where an issue may be.

20. The method of claim 1, wherein said network controller application provides collaborating with data center engineers and leverage of a virtual assistant.

21. The method of claim 1, wherein said network controller application provides an infrastructure timeline for all alerts, incidents, changes and updates.

22. The method of claim 1, wherein said network controller application provides real time updates, a view of any changes, and a view of any carrier maintenances or issues.

23. The method of claim 1, wherein said network controller application provides security visibility and instant action to mitigate any attack instantly.

24. An apparatus for managing a network, comprising:
an intermediary module to which user network requests are directed, said requests received from a remote device comprising a self-organizing network controller application for user entry of network requests via the remote device to a data center comprising any of one or more routers, switches, and firewalls;
said intermediary module comprising instructions that, when executed by a processor:
execute commands from said remote device through an API by:
opening a screen via an app on the remote device that is associated with the intermediary module;
upon opening the screen on the remote device the application hits an API endpoint, wherein the API endpoint is RestFul based where it validates the incoming request;
validating a token of the user to determine that the user is authorized to call a specific API;
once the request passes the API, creating an internal call to a service which generates a native command that operates on the device, based on configurations provided for each device;
once the command is generated, an SSH tunnel is opened to the device and then the command is executed;
once the command is executed, another service parses a response and then it converts it to a JSON based response.

25. The apparatus of claim 24, wherein said intermediary module comprising instructions that, when executed by a processor:
execute commands from said remote device through direct connection via any of a VPN connection or by whitelisting a public IP address of the remote device on the firewall level that accesses a private subnet.

26. A method for managing a network, comprising:
providing a remote device having a dedicated app configured to send requests and commands to, and receive responses from, a data center comprising any of one or more routers, switches, and firewalls;
said remote device, via said app, sending requests and commands to, and receiving responses from, said data center via the Internet;
said remote device accessing the Internet via any of Wi-Fi, cellular, or any other network;
said dedicated app configured to send said requests and commands to, and receive said responses from, said data center via an API associated with an intermediary module interposed between said remote device and said data center for validating said user network requests received from said remote device.

27. The method of claim 26, wherein said intermediary module comprises a self-organizing network controller application for user entry of network requests via the remote device, wherein said intermediary module determines that said user is authorized to call said API; wherein said intermediary module creates an internal call to generate a native command that works on the remote device, based on configurations provided for said remote device; wherein once the native command is generated, said intermediary module opens an SSH tunnel to the remote device; wherein said intermediary module executes the user request; wherein said intermediary module parses a response to said request; wherein said intermediary module converts said response to a JSON based response; and wherein said intermediary module returns said JSON based response to said remote device.

28. An apparatus for managing a network, comprising:
a remote device having a dedicated app configured to send requests and commands to, and receive responses from, a data center comprising any of one or more routers, switches, and firewalls;
wherein said remote device, via said app, sends requests and commands to, and receiving responses from, said data center via the Internet;
wherein said remote device accesses the Internet via any of Wi-Fi, cellular, or any other network;
said dedicated app configured to send said requests and commands to, and receive said responses from, said data center via an API associated with an intermediary module to which user network requests are directed, said requests received from said remote device.

29. The apparatus of claim 28, wherein said intermediary module comprises a self-organizing network controller application for user entry of network requests via the remote device;
said intermediary module comprising instructions that, when executed by a processor:
execute commands from said remote device through said API by:
opening a screen on said remote device via said app;
upon opening the screen the application hits an API endpoint, wherein the API endpoint is RestFul based where it validates the incoming request;
validating a token of the user to determine that the user is authorized to call a specific API;
once the request passes the API, creating an internal call to a service which generates a native command that operates on the remove device, based on configurations provided for each device;
once the command is generated, an SSH tunnel is opened to the remote device and then the command is executed;
once the command is executed, another service parses a response and then the other serviced converts response to a JSON based response which is provided to and displayed on the remote device screen via the app.
